(19) United States
(12) Patent Application Publication
(10) Pub. No.: US 2018/0004521 A1
(43) Pub. Date: Jan. 4, 2018

(54) PROCESSORS, METHODS, AND SYSTEMS TO IDENTIFY STORES THAT CAUSE REMOTE TRANSACTIONAL EXECUTION ABORTS

(71) Applicant: Intel Corporation, Santa Clara, CA (US)

(72) Inventors: Andreas Kleen, Portland, OR (US); Raanan Sade, Kibutz Sarid (IL); Ahmad Yasin, Haifa (IL); Ravi Rajwar, Portland, OR (US); Robert S. Chappell, Portland, OR (US); Roman Dementiev, Heidelberg (DE)

(73) Assignee: Intel Corporation, Santa Clara, CA (US)

(21) Appl. No.: 15/200,676

(22) Filed: Jul. 1, 2016

(51) Int. Cl. G06F 9/30; G06F 12/0815; G06F 3/06; G06F 12/084

(52) U.S. Cl. CPC G06F 9/30043; G06F 12/084; G06F 12/0815; G06F 9/30145; G06F 3/0619; G06F 3/0656; G06F 3/0653; G06F 3/0673

(57) ABSTRACT

A method of analyzing aborts of transactional execution transactions. Starting a transactional execution transaction with a first logical processor. Performing, with a second logical processor, store to memory instructions, while the first logical processor is performing the transactional execution transaction. Capturing memory addresses of, and instruction pointer values associated with, at least a sample of the store to memory instructions. Performing, with the second logical processor, a first store to memory instruction to a first memory address, which is to cause the transactional execution transaction to abort. Capturing the first memory address. Determining an instruction pointer value associated with the first store to memory instruction by correlating at least the captured first memory address with the captured memory addresses of said at least the sample of the store to memory instructions.

### BACKGROUND

### Technical Field

Embodiments described herein generally relate to computer systems. In particular, embodiments described herein generally relate to performance monitoring.

### Background Information

Many modern processors have performance monitoring logic. The performance monitoring logic may be used to sample or count various different types of architectural and microarchitectural events that may occur within the processor while it is performing software. Hardware and software developers may use such performance monitoring data to better understand the interactions between the software and the processor. Often, such data may be used to debug software and/or hardware, tune software and/or hardware, identify or characterize factors that limit performance, and the like.

### BRIEF DESCRIPTION OF THE DRAWINGS

The invention may best be understood by referring to the following description and accompanying drawings that are used to illustrate embodiments. In the drawings:

FIG. 1 is a block diagram of an embodiment of a computer system in which embodiments of the invention may be implemented.

FIG. 2 is a block diagram of an example embodiment of a transaction performed by a first logical processor, and code performed by a second logical processor that causes the transaction to abort.

FIG. 3 is a block flow diagram of an embodiment of a method of analyzing aborts of transactional execution transactions.

FIG. 4 is a block diagram of an embodiment of a processor in which embodiments of the invention may be implemented.

FIG. 5A is a block diagram of a first set of performance monitoring data that may be sampled for all reads and stores performed by a second logical processor while a first logical processor performs a transactional execution transaction.

FIG. 5B is a block diagram of a second set of performance data that may be sampled for all stores performed by a second logical processor that cause a transactional execution transaction being performed by a first logical processor to abort.

FIG. 6 is a block diagram of a performance analysis module having an embodiment of a remote transactional execution abort analysis module.

FIG. 7A is a block diagram illustrating an embodiment of an in-order pipeline and an embodiment of a register renaming out-of-order issue/execution pipeline.

FIG. 7B is a block diagram of an embodiment of processor core including a front end unit coupled to an execution engine unit and both coupled to a memory unit.

FIG. 8A is a block diagram of an embodiment of a single processor core, along with its connection to the on-die interconnect network, and with its local subset of the Level 2 (L2) cache.

FIG. 8B is a block diagram of an embodiment of an expanded view of part of the processor core of FIG. 8A.

FIG. 9 is a block diagram of an embodiment of a processor that may have more than one core, may have an integrated memory controller, and may have integrated graphics.

FIG. 10 is a block diagram of a first embodiment of a computer architecture.

FIG. 11 is a block diagram of a second embodiment of a computer architecture.

FIG. 12 is a block diagram of a third embodiment of a computer architecture.

FIG. 13 is a block diagram of an embodiment of a system-on-a-chip architecture.

FIG. 14 is a block diagram of use of a software instruction converter to convert binary instructions in a source instruction set to binary instructions in a target instruction set, according to embodiments of the invention.

### DETAILED DESCRIPTION OF EMBODIMENTS

Disclosed herein are embodiments of processors, methods, systems, and programs or machine-readable mediums to identify stores from a remote logical processor that cause transactional execution of another logical processor to abort. In the following description, numerous specific details are set forth (e.g., specific types of performance monitoring events, methods of analysis, processor configurations, sequences of operations, etc.). However, embodiments may be practiced without these specific details. In other instances, well-known circuits, structures and techniques have not been shown in detail to avoid obscuring the understanding of the description.

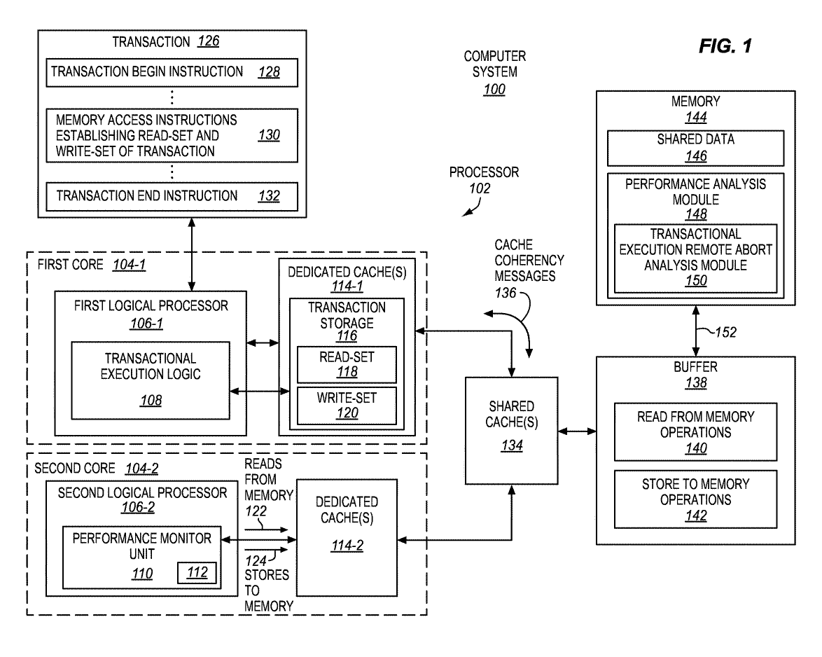

FIG. 1 is a block diagram of an embodiment of a computer system 100 in which embodiments of the invention may be implemented. In various embodiments, the computer system may be a desktop computer, a laptop computer, a notebook computer, a tablet computer, a netbook, a smartphone, a cellular phone, a server, a network device (e.g., a router, switch, etc.), a media player, a smart television, a nettop, a set-top box, a video game controller, or other type of electronic device. The computer system includes a processor 102 and a memory 144 coupled with the processor. The processor and the memory may be coupled, or otherwise in communication with one another, by one or more conventional coupling mechanisms 152 (e.g., through one or more buses, hubs, memory controllers, chipset components, or the like).

The processor 102 includes two or more processing elements or logical processors 106. For simplicity of illustration, only a first logical processor 106-1 and a second logical processor 106-2 are shown, although there may optionally be additional logical processors. The first logical processor is included in a first core 104-1. The second logical processor is included in a second core 104-2. In the illustrated embodiment, the first and second logical processors are both part of the same processor (e.g., may be physically located on the same die), although in other embodiments one or more of the logical processors may optionally be part of a different processor (e.g., be located on a different die). Examples of suitable logical processors or processor elements include, but are not limited to, cores, hardware threads, thread units, thread slots, logic operative to store a context or architectural state and a program counter or instruction pointer, logic operative to store state and be independently associated with code, and the like.

The first logical processor 106-1 is coupled with a first set of one or more levels of one or more dedicated caches 114-1, which are dedicated to the first core. Likewise, the second logical processor 106-2 is coupled with a second set of one or more levels of one or more dedicated caches 114-2, which are dedicated to the second core. The processor also optionally has one or more levels of one or more shared caches 134 that are relatively farther in the cache or memory access hierarchy from the execution units, and closer in the cache or memory access hierarchy to the memory 144, than the dedicated caches 114. The scope of the invention is not limited to any known number or arrangement of caches. Often, there may be at least one dedicated cache per core, and at least one shared cache, although the scope of the invention is not so limited. The caches are often used to cache or store a portion of the data from the memory 144. Read from memory instructions, and store to memory instructions, generally first access the caches with their operations.

The memory may have shared data 146 that is shared by two or more of the logical processors 106. One challenge that may be encountered, in systems having two or more logical processors, and especially in systems having many more than two logical processors, is a generally greater need for synchronizing or otherwise controlling concurrent accesses to such shared data among the logical processors. One way to synchronize or otherwise control concurrent accesses to the shared data involves using locks or semaphores to guarantee mutual exclusion of accesses across multiple logical processors. However, such use of semaphores or locks may tend to have certain drawbacks.

In some embodiments, the processor 102 and/or at least the first logical processor 106-1 may include transactional execution logic 108 that is operative to support transactional execution. Transactional execution broadly represents an approach to use transactions to control concurrent accesses to shared data by two or more logical processors. Some forms of transactional execution may help to reduce or avoid the use of locks or semaphores. One specific suitable example of such a form of transactional execution, for some embodiments, is Restricted Transactional Memory (RTM) of Intel® Transactional Synchronization Extensions (Intel® TSX) form of transactional execution, although the scope of the invention is not so limited. Other forms of transactional execution may help to improve performance by allowing the locks to be performed speculatively in parallel. One specific suitable example of such a form of transactional execution, for some embodiments, is Hardware Lock Elision (HLE) of Intel® Transactional Synchronization Extensions (Intel® TSX) form of transactional execution, although the scope of the invention is not so limited. The transactional execution as described herein may, in some embodiments, have any one or more, or optionally substantially all, of the features of RTM and/or HLE and/or Intel® TSX, although the scope of the invention is not so limited.

In various embodiments, the transactional execution may be purely hardware transactional memory (HTM), unbounded transactional memory (UTM), and hardware supported (e.g., accelerated) software transactional memory (STM) (hardware supported STM). In hardware transactional memory (HTM), one or more or all of the tracking of memory accesses, conflict resolution, abort tasks, and other transactional tasks may be performed predominantly or entirely in on-die hardware (e.g., circuitry) or other logic (e.g., any combination of hardware and firmware or other control signals stored in on-die non-volatile memory) of the processor. In unbounded transactional memory (UTM), both on-die processor logic and software may be used together to implement transactional memory. For example, UTM may use a substantially HTM approach to handle relatively smaller transactions while using substantially more software in combination with some hardware or other on-die processor logic to handle relatively larger transactions (e.g., unbounded sized transactions which may be too big for the on-die processor logic to handle by itself). In still embodiments, even when software is handling some portion of the transactional memory, hardware or other on-die processor logic may be used to assist, accelerate, or otherwise support the transactional memory through on-die processor logic supported STM.

Referring again to FIG. 1, during operation, the first logical processor 106-1 may be operative to perform a transaction 126. The transaction may represent a programmer specified section or portion of code. The transactional execution may be operative to allow all instructions and/or operations within the transaction (e.g., memory access instructions 130) to be transparently performed atomically. The atomicity implies in part that the transaction (e.g., all of the instructions and/or operations of the transaction) is either performed fully, or not at all, but is not performed only partially. Within the transaction, data may only be read, but not written within the transaction non-speculatively or in a way that is globally visible. If the transactional execution is successful, then writes to the data by instructions within the transaction may be performed atomically.

The transaction includes a transaction begin instruction 128 that is operative to begin the transaction. One specific example of a suitable transaction begin instruction is the XBEGIN instruction in RTM transactional memory, although the scope of the invention is not so limited. Within the transaction, there may be at least one, but potentially a relatively large number, of the memory access instructions 130 (e.g., read from memory instructions, store to memory instructions, etc.). These memory access instructions may establish the read-set 118 and the write-set 120 of the transaction. Memory addresses loaded or otherwise read from within the transaction may establish the read-set. Memory addresses written or otherwise stored to within the transaction may establish the write-set. Until the transaction is completed and committed successfully, the memory access operations associated with these memory access instructions 130 of the transaction may be temporarily buffered or stored in a transaction storage 116. As shown, in some embodiments, the transaction storage may optionally be implemented in one of the dedicated cache(s) 114-1, such as, for example, in an L1 cache, corresponding to the first logical processor. Alternatively, the transaction storage may optionally be implemented in a shared cache (e.g., one of the shared cache(s) 134), a different dedicated storage, or other buffer or storage of the processor.

If the transaction 126 succeeds and is committed, then these speculative memory access operations of the transaction, which are buffered in the transaction storage 116, may be atomically committed to the memory 144. A transaction end instruction 132 may be used to end the transaction in such a case. One specific example of a suitable transaction end instruction is the XEND instruction in RTM transactional memory, although the scope of the invention is not so limited. Alternatively, if the transaction aborts or fails, then these speculative memory access operations of the transaction, which are buffered in the transaction storage, may be aborted, discarded, or otherwise not performed (e.g., they may never be made architecturally visible to any of the other logical processors except for the first logical processor 106-1). In some embodiments, the processor may also restore the architectural state to appear as if the transaction had never occurred. Accordingly, the transactional execution may provide an undo capability, which may allow speculatively or transactionally performed updates to memory to be undone, without ever being visible to other logical processors, in the event of a transaction abort.

There are various possible reasons to abort a transaction, depending upon the particular implementation. For example, an abort may be performed due to insufficient transactional resources, for certain types of exceptions or other system events, or if an abort instruction is issued. Another possible reason to abort the transaction is due to detection of a data conflict. The data conflict may represent a conflicting access to shared data due to a memory access instruction being performed by another logical processor in the system. For example, such a data conflict may be detected if another logical processor in the system (e.g., the second logical processor 106-2) either reads a memory location that is part of the transaction's write-set 120 and/or writes a memory location that is a part of either the read-set 118 or the write-set 120. The risk of having the transaction aborted or killed by another logical processor may persist until the transaction is successfully committed (e.g., the transaction end instruction 132 is performed). Commonly, the processor 102 and/or the transactional execution logic 108 may include on-die memory access monitor hardware and/or other logic to autonomously monitor memory accesses, and detect such conflicts. Especially when the transaction involves a relatively large number of instructions, aborting the transaction may be costly in terms of performance. It is generally desirable to avoid aborting the transaction. Advantageously, the approaches disclosed herein may be used to help identify instructions that cause data conflict aborts, which may be used to help avoid at least some such aborts.

During operation, the second logical processor 106-2 may perform various different instructions associated with its workload, including read from memory instructions that cause reads from memory 122 and store to memory instructions that cause stores to memory 124. These memory accesses may first check the caches (e.g., the caches 114-2, 134, etc.). These caches (e.g., their cache controllers) may implement a cache coherency protocol, and may exchange cache coherency messages 136 to indicate cache coherency related information (e.g., when data for a read is found in another cache, when a store hits in another cache, etc.). In the illustrated embodiment, these messages 136 are exchanged through the shared cache(s) 134. In other embodiments these messages 136 may be exchanged on various interconnects suitable for exchanging messages between dedicated caches. In addition, before going to memory, these read from memory operations 140 and store to memory operations 142 may be stored in a buffer 138 of the processor. The buffer may represent a memory order buffer, a load and store buffer, etc.

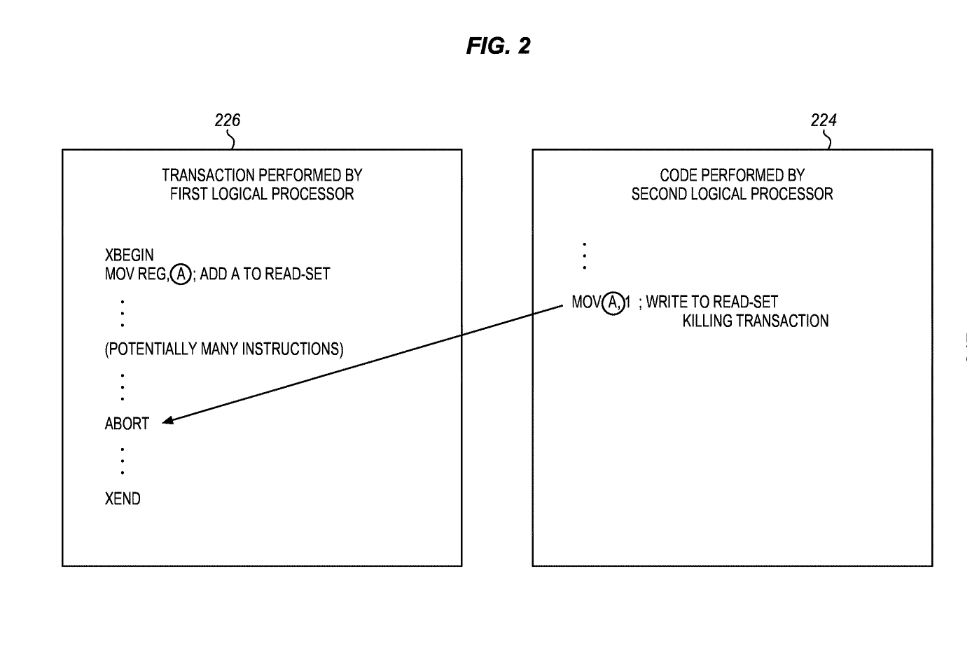

Some of the reads from memory 122 from the second logical processor 106-2 and/or some of the stores to memory 124 from the second logical processor 106-2 may potentially cause a data conflict that causes an abort of the transaction 126 performed by the first logical processor 106-1. The second logical processor may include a performance monitor unit 110 that may include an embodiment of logic 112 to identify store to memory instructions that cause remote transactions to abort. To further illustrate certain concepts, one possible example of such an abort is described in conjunction with FIG. 2.

FIG. 2 is a block diagram of an example embodiment of a transaction 226 that may be performed by a first logical processor, and code 224 that may be performed by a second logical processor that causes the transaction 226 to abort. The transaction begins with a transaction begin instruction, which in this example is an XBEGIN instruction. A MOV instruction is then used to move a memory operand A from a given memory address to a processor register (REG). This may add the memory address of the operand A to the read set of the transaction. Other instructions, including potentially a large number of instructions, may then be performed within the transaction. Sometime before a transaction end instruction is performed, which in this example is an XEND instruction, the code 224 being performed by the second logical processor may perform a MOV instruction to move a value of 1 to the same given memory address of the memory operand A. This may represent a write to the read set of the transaction 226, which may cause the transaction to be aborted (ABORT). This may tend to reduce performance, especially when a large number of instructions have already been performed within the transaction, and is generally undesirable. Especially when transactions get aborted often, it may tend to significantly diminish the benefits that transactional execution can provide.

In order to help make transactional execution more effective, it would be useful and beneficial to be able to identify instructions performed by other logical processors (e.g., instruction pointer values) that cause transactions to abort. For example, it would be good to be able to identify the instruction pointer of the MOV instruction of the code 224. However, in practice this often tends to be difficult and/or time consuming to accomplish. For example, this tends to be especially the case in complex code applications and code bases. In some cases, it may take weeks, if not longer, to discover the instructions which cause remote transaction aborts (sometimes referred to as transaction killers) in order to allow applications to be tuned or modified to be more compatible with transactional execution.

One aspect, which tends to contribute to making the identification of store to memory instructions (e.g., the MOV instruction of the code 224) which kill remote transactions (e.g., the transaction 226) difficult to identify, is that the store to memory instructions commonly retire before their associated store operations have completed thereby causing the aborts. For example, the store to memory instructions are commonly retired while their store to memory operations are buffered in a store buffer of the processor. Once retired, the instruction pointer values for the store to memory instructions are generally no longer available. Only later, after the store to memory instructions have retired, and their instruction pointer values are no longer available, are the store operations actually performed (e.g., and the data conflicts that cause the aborts detected).

Commonly, the only instruction pointer values that are available, when the store to memory operations are known to have caused a transaction to abort, have relatively long “skids” or displacements from the actual instruction pointers of the store to memory instructions corresponding to those store to memory operations, due in part to store positing. This may contribute to making it challenging and/or time consuming to identify the actual instruction pointer values for the store to memory instructions whose corresponding store to memory operations caused a transaction to abort. Read from memory instructions that are transaction killers may also be challenging to identify, but may not encounter the aforementioned challenge of stores. For example, such read from memory instructions typically wait for data to come back from memory before they are retired. Accordingly, for read from memory instructions the instruction pointer value may not be lost until after it is known whether or not the read from memory instruction have caused a transaction to abort.

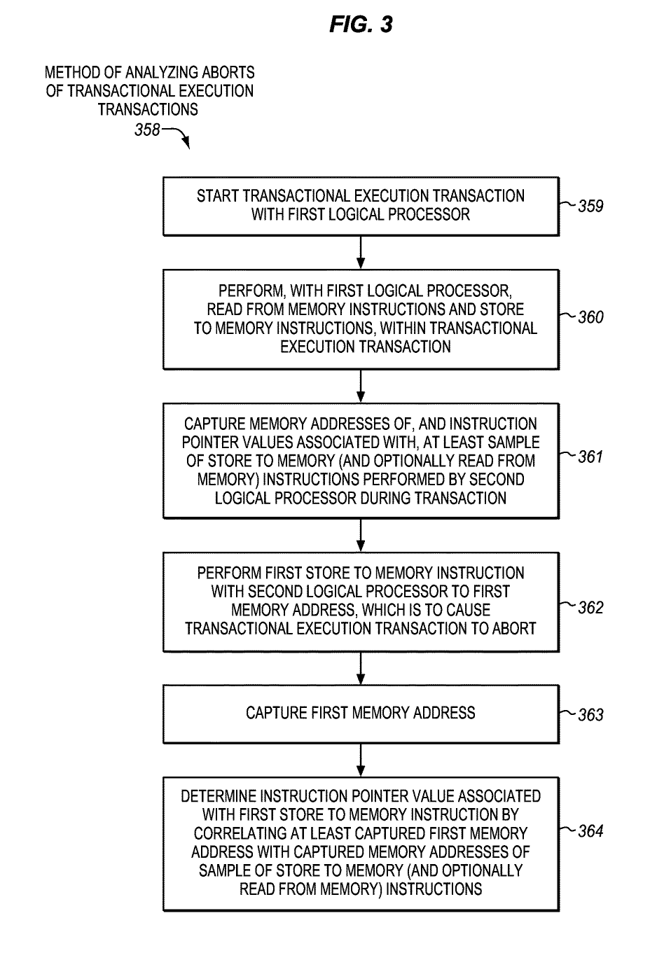

FIG. 3 is a block flow diagram of an embodiment of a method 358 of analyzing aborts of transactional execution transactions. The method includes starting a transactional execution transaction with a first logical processor, at block 359. At block 360, the method also includes performing, with the first logical processor, a plurality of read from memory instructions, and a plurality of store to memory instructions, within the transactional execution transaction. These may establish a read-set and a write-set of the transaction.

At block 361, memory addresses of, and instruction pointer values associated with, at least a sample of read from memory instructions, and store to memory instructions, which are performed by a second logical processor (e.g., a different logical processor than the first logical processor which is performing the transactional execution transaction), may be captured. In some embodiments, this may be performed by programming or configuring performance monitoring logic to capture the memory addresses (e.g., virtual memory addresses) and instruction pointer values. In some embodiments, time stamp values associated with at least the sample of the read from memory instructions, and the store to memory instructions, which are performed by a second logical processor, may also optionally be captured, although this is not required.

In some embodiments, such data may be captured with so-called “precise” monitoring. By way of example, in one embodiment, the instruction pointer values may be captured with a precise event based sampling mode in which counters may be configured to overflow, interrupt the processor (e.g., with a real or architectural interrupt or a microcode trap), and capture machine state at that point in time. In addition, it may be possible, in such a precise monitoring mode, not to interrupt the processor for each sample, but rather let the processor instead just store sample data (e.g., write a record to memory) on its own. This may help to reduce overhead of sampling and/or allow a higher sampling rate. One suitable example of such precise monitoring is Precise Event Based Monitoring (PEBS) available for certain processors from Intel Corporation, of Santa Clara, Calif., although the scope of the invention is not so limited. Rather than capturing such data for all of the read and store instructions, often such data may be captured for only a sample of all of the read and store instructions (e.g., to avoid a performance degradation due to the performance monitoring).

Referring again to FIG. 3, a first store to memory instruction may be performed, with the second logical processor (e.g., a different logical processor than the first logical processor which is performing the transactional execution transaction), to a first memory address, at block 362. The performance of this first store to memory instruction may cause an abort of the transactional execution transaction (e.g., which is being performed by the first logical processor). For example, this may be the case when the first memory address has a data conflict with one of a read-set and a write-set of the transactional execution transaction.

At block 363, the first memory address, which caused the transactional execution transaction to abort, may be captured. In some embodiments, this may be performed by programming or configuring performance monitoring logic to capture the first memory address at times when it is known that the first store to memory instruction has caused the transactional execution transaction to abort. In some embodiments, a first time stamp associated with the first store to memory instruction may also optionally be captured, although this is not required. Rather than capturing such data for all such instructions that cause transactional execution transactions to abort, optionally such data may be captured for only a sample of all such instructions (e.g., to avoid a performance degradation due to the performance monitoring).

Then, at block 364, an instruction pointer value associated with the first store to memory instruction may be determined. In some embodiments, this determination may be made by matching or otherwise correlating at least the captured first memory address (e.g., which was captured at block 363) with the captured memory addresses of at least the sample of the read from memory instructions and the store to memory instructions (e.g., which were captured at block 361). For example, the memory addresses may be compared to identify a matching or identical memory address to the first memory address, and its associated instruction pointer value. In some embodiments, the first time stamp value associated with the first store to memory instruction (if optionally captured) may optionally be correlated with the time stamp values for at least the sample of the read from memory and store to memory instructions (if captured), although this is not required. Advantageously, the determined instruction pointer value may identify, or at least make it easier to identify, the first store to memory instruction, which killed or aborted the remote transaction. This in turn may be used to help tune software and/or the processor (e.g., transactional execution controls) to help eliminate or at least reduce the number of such stores which abort remote transactions.

For simplicity in the illustration and associated description, the method has been described for a single transaction, and a single first store to memory instruction which causes the transaction to abort. However, it is to be appreciated that the method may also be extended to include multiple overlapping transactions and multiple store to memory instructions that cause some of the transactions to abort. In addition, while store to memory operations have been described, a similar approach may optionally be used for read from memory instructions that have a data conflict with a transaction (e.g., a read from the write set of the transaction).

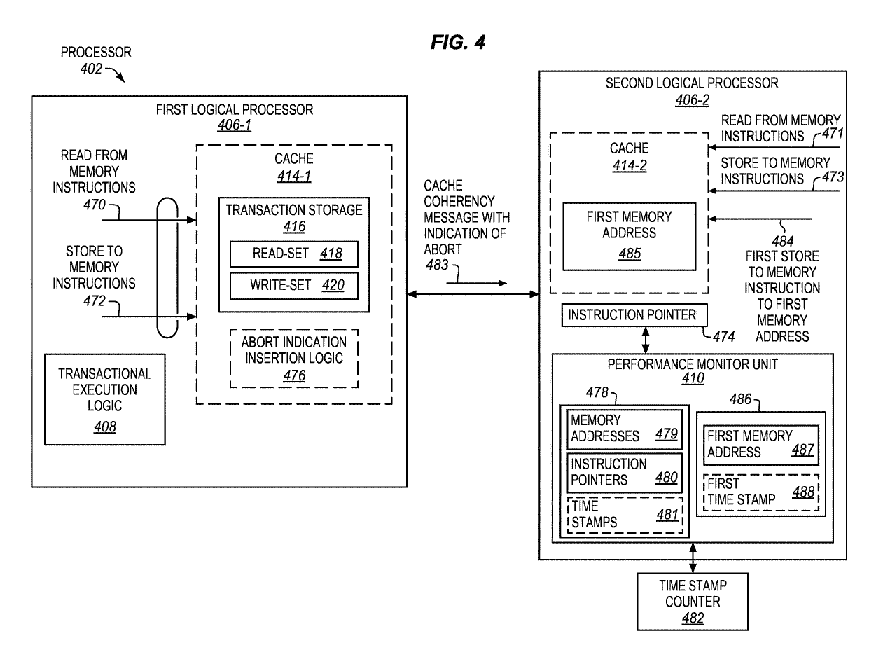

FIG. 4 is a block diagram of an embodiment of a processor 402 in which embodiments of the invention may be implemented. In some embodiments, the processor 402 may optionally perform the method 358 of FIG. 3. The components, features, and specific optional details described herein for the processor 402 also optionally apply to the method 358. Alternatively, the method 358 may optionally be performed by and/or within a similar or different processor or apparatus. Moreover, the processor 402 may optionally perform methods similar to, or different than, the method 358.

The processor includes a first logical processor 406-1, a second logical processor 406-2, and may optionally include additional logical processors (not shown). The first logical processor includes transactional execution logic 408. The transactional execution logic may be similar to, or the same as that previously described, and may be implemented in hardware, firmware, software, or a combination thereof (e.g., generally including at least some hardware and/or at least some firmware). The transactional execution logic is operative to perform a transactional execution transaction. One or more read from memory instructions 470, and one or more store to memory instructions 472, may be performed within the transaction. The read and store instructions 470, 472 may establish a read-set 418 and a write-set 420 of the transaction. The associated read and store operations for these read and store instructions may be buffered or held in a transaction storage 416 until the transaction is committed. The transaction storage may optionally be implemented in a cache 414-1 of the first logical processor. The transactional execution logic may also be operative to detect data conflicts that cause transaction aborts.

Referring again to FIG. 4, the processor also has the second logical processor 406-2. During operation, the second logical processor may perform read from memory instructions 471, and store to memory instructions 473, associated with its workload. A few representative examples of such instructions include, but are not limited to, load instructions, move instructions, read instructions, gather instructions, load multiple instructions, store instructions, write instructions, scatter instructions, store multiple instructions, and the like. As one of the store to memory instructions, the second logical processor may perform a first store to memory instruction 484 which stores data to a first memory address.

The second logical processor also has a performance monitor unit 410. The performance monitor unit may be implemented in hardware, firmware, software, or a combination thereof (e.g., at least some hardware and/or firmware potentially combined with some software). The performance monitor unit may be operative to capture a first set of performance monitor data 478. The first set of performance monitor data may include memory addresses 479 (e.g., virtual memory addresses) of at least a sample of the read from memory instructions 471, and the store to memory instructions 473. The performance monitor unit may also be operative to capture instruction pointer values 480 associated with at least the sample of the read from memory instructions 471, and the store to memory instructions 473. As shown, the performance monitor unit may optionally be coupled with an instruction pointer 474, or otherwise be operative to receive the instruction pointer values. In some embodiments, the performance monitor unit may also optionally be operative to capture time stamps or time stamp values 481 associated with at least the sample of the read from memory instructions 471, and the store to memory instructions 473, although this is not required. As shown, in such cases, the performance monitor unit may optionally be coupled with a time stamp counter 482, or otherwise be operative to receive the time stamps. In some embodiments, the performance monitor unit may also optionally be operative to capture call stacks, or call stacks may be captured in software on an overflow interrupt, although this is not required. By way of example, the call stacks may later be correlated with the instruction pointer values and then reported to the user in a profiling tool. Once collected, the data 478 may optionally be transferred to a performance monitoring record, buffer, or other such storage (e.g., in memory).

In some embodiments, the performance monitor unit 410 may be programmed or configured to sample such data or events. For example, a first set of one or more registers of the processor (e.g., event selection control registers, counter configuration control registers, machine specific registers (MSRs), or the like) may be programmed or configured to cause the performance monitor unit to sample such data or events. Such registers may program or configure event counters (e.g., 32-bit, 48-bit, or other sized event counters) to count instances of these events. By way of example, a read and store counter may be programmed to a negative value representing a sampling period or threshold, and may be incremented for each read from memory instruction, and for each store to memory instruction, until the negative value becomes a zero value. The counter reaching the zero value may indicate that the threshold or sampling interval has been reached. Counting to zero is not required, but rather counting to a positive value may also optionally be used. When the sampling interval is reached, sample data may be collected for the next read from memory instruction or store to memory instruction. In some embodiments, this may be performed by processor logic instead of software, since there may be more skid if software were used. As one example, this may be achieved through a profiling interrupt being performed.

In some embodiments, the performance monitor unit may be operative to capture at least the instruction pointer values with a so-called “precise” performance monitor approach. By way of example, in one embodiment, the instruction pointer values may be captured with a precise event based sampling mode in which counters may be configured to overflow, interrupt the processor (e.g., with a real or architectural interrupt or a microcode trap), and capture machine state at that point in time. In addition, it may be possible, in such a precise mode, not to interrupt the processor for each sample, but rather let the processor instead just store sample data (e.g., write a record to memory) on its own. This may help to reduce overhead of sampling and/or allow a higher sampling rate. One suitable example of such precise monitoring is PEBS, although the scope of the invention is not so limited. The use of such a precise monitoring approach may help to allow capturing the instruction pointers with relatively small “skid” or displacement from the actual instruction pointer values.

The second logical processor during operation may also perform a first store to memory instruction 484 to store data to a first memory address. The store operation corresponding to the first store to memory instruction, including the first memory address 485 (e.g., encompassing an address translation thereof), may be cached or stored in a cache 414-2 of the second logical processor. Commonly, the cache may store physical memory addresses, rather than virtual memory addresses.

In some embodiments, the first memory address 485 may have a data conflict with the transaction. For example, this may be the case if the first memory address has a data conflict with either the read-set 418 and/or the write-set 420 of the transaction. In such embodiments, the first logical processor may abort the transaction, and may provide an indication that the first memory address has caused the transaction to abort. This indication may be provided in different ways in different embodiments. In some embodiments, this indication may optionally be provided in a cache coherency protocol message 483 corresponding to the store operation for the first memory address. Such cache coherency protocol messages may be sent or exchanged between the first logical processor, the second logical processor, and other logical processors in the system (if any) to maintain cache coherency. In some embodiments, such cache coherency protocol messages may optionally be extended to include an additional field or set of one or more bits in a unique combination to make such an indication. For example, a first bit or field in the cache coherency message may have a first value to indicate a transaction abort, or a second different value to indicate no transaction abort. Alternatively, in other embodiments, there may optionally be a separate dedicated message, communication, or signal to provide this indication.

In some embodiments, the performance monitor unit 410 may be operative to capture a second set of performance monitor data 486 including the first memory address 487, in response to the indication (e.g., as conveyed through the cache coherency message 483), from the first logical processor, that the first memory address has caused the transactional execution transaction to abort. For example, the performance monitor unit may count as events cache coherency protocol messages sent back with an indication of a transaction abort. By way of example, the first memory address 487 may be captured from the first memory address 485 stored in an entry in the cache, or from the first memory address stored in a store buffer, or from the cache coherency protocol message 483, or from miss handling buffer or fill buffer. In some embodiments, the performance monitor unit may also capture a time stamp or time stamp value 488 associated with a store to memory operation corresponding to the first store to memory instruction 484, although this is not required. As shown, in such cases, the performance monitor unit 410 may optionally be coupled with a time stamp counter 482, or otherwise be operative to receive such time stamps.

Commonly, the cache 414-2 may store the first memory address 485 as a physical memory address, rather than a virtual memory address. In cases where the first memory address is a physical memory address, it may optionally be later (e.g., by a profiler module or other performance analysis module) converted to a virtual address. This may be performed through a reverse address translation process (e.g., going from a physical memory address to a virtual memory address, instead of the normal address translation process of going from a virtual memory address to a physical memory address). Page tables managed by the operating system, and in the case of a virtualized environment extended or other second level page tables, managed by a virtual machine monitor or hypervisor, may be used for this purpose. Alternatively, the memory addresses 479 may be virtual addresses and may optionally be converted to a physical memory address with page tables so that they may be compared to the first memory address which may be a physical address.

In some embodiments, the performance monitor unit 410 may be programmed or configured to sample such data or events. For example, a set of one or more registers of the processor (e.g., event selection control registers, counter configuration control registers, machine specific registers (MSRs), or the like) may be programmed or configured to cause the performance monitor unit to sample such data or events. Such registers may program or configure event counters (e.g., 32-bit, 48-bit, or other sized event counters) to count instances of these events. By way of example, a store transaction kill counter may be programmed to a negative value representing a sampling period or threshold, and the store transaction kill counter may be incremented for each received cache coherency protocol message with an indication of a transaction abort, until the negative value becomes a zero value. The counter reaching the zero value may indicate that the threshold or sampling interval has been reached. Counting to zero is not required, but rather counting to a positive value may also optionally be used. When the threshold or sampling interval has been reached, sample data to be collected for the first memory address for the next store instruction that causes a transaction abort.

In some embodiments, a performance monitor approach used to capture the first memory address 487 and/or the optional time stamp 488 may be relatively less “precise” than a performance monitor approach used to capture the instruction pointer values 480. For example, as previously described, the instruction pointer values may be captured with PEBS or another such precise event based sampling approach. In contrast, the first memory address 487 may optionally be captured with a non-precise event based sampling mode in which all information logged may not necessarily be specific to the instruction. The non-precise approach may also help to report the event relatively soon (e.g., fired immediately as soon as the next instruction retires) without needlessly waiting for the next occurrence of the monitored event. In the non-precise approach, a new register may be used, and may offer an advantage that it is easier to intercept by a virtual machine that wants to present its own view of guest physical address versus host physical address.

In some embodiments, a buffer (e.g., a store buffer) may also be used to keep information associated with the store to memory operations (e.g., instruction pointer values) around longer than it usually would, although this is not required. For example, the store buffer of the second logical processor may be operative to wait to remove an entry, which corresponds to the first store to memory instruction, until receipt of the indication from the first logical processor about whether the first store to memory instruction caused a transaction to abort. In this way, if the indication is that the first store to memory instruction did cause the transaction to abort, then the information associated with the store may still be present in the store buffer.

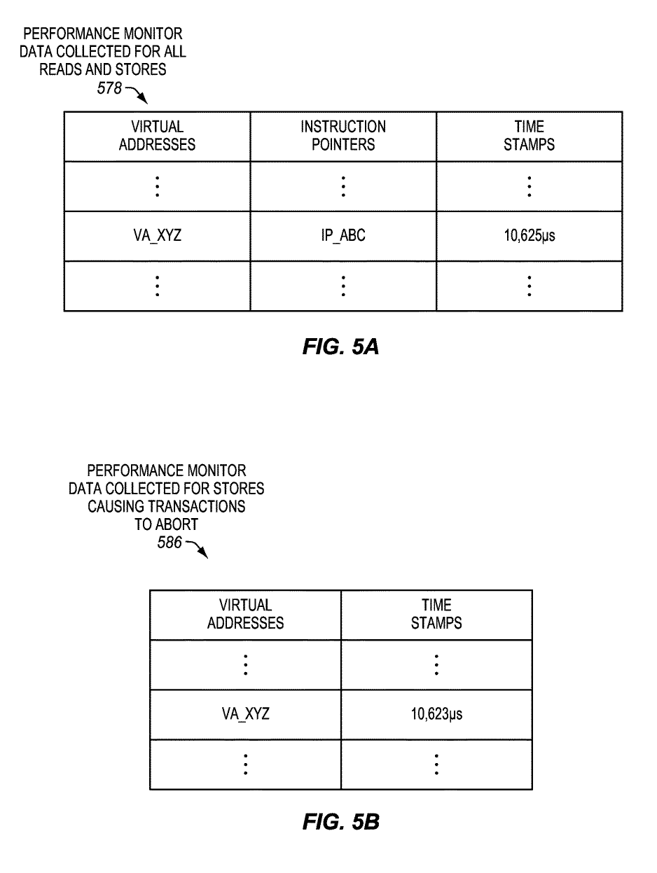

FIG. 5A is a block diagram of a first set of performance monitoring data 578, which may be sampled for all reads and stores performed by a second logical processor, while a first logical processor performs a transactional execution transaction. The data 578 represents one suitable example for the first set of performance monitor data 478 of FIG. 4. The illustrated performance data is in the form of a table, although other data structures may optionally be used if desired. The data is arranged as a table with a column for virtual memory addresses, instruction pointer values, and time stamp values. For each sampled read and store, a corresponding virtual memory address, instruction pointer value, and optionally a time stamp value are obtained. As shown, a given read or store may have a given virtual memory address (VA_XYZ), a given instruction pointer value (IP_ABC), and a given time stamp value (e.g., 10,625 microseconds as one example).

FIG. 5B is a block diagram of a second set of performance data 586, which may be sampled for all stores performed by a second logical processor, which cause a transactional execution transaction being performed by a first logical processor to abort. The data 586 represents one suitable example for the second set of performance monitor data 486 of FIG. 4. The illustrated performance data is in the form of a table, although other data structures may optionally be used if desired. The data is arranged as a table with a column for virtual memory addresses (or alternatively physical memory addresses could be stored) and time stamp values. For each sampled store that causes a transaction to abort, a corresponding virtual memory address and optionally a time stamp value are obtained. As shown, a given transaction killing store may have a given virtual memory address (VA_XYZ) and a given time stamp value (e.g., 10,623 microseconds as one example).

Notice that the virtual memory address (VA_XYZ) in FIG. 5B identically matches the virtual memory address (VA_XYZ) in FIG. 5A. This may be used to correlate the transaction killing store of FIG. 5B with one of the reads and stores of FIG. 5A. If desired, the corresponding given time stamp value (e.g., 10,623 microseconds) of FIG. 5B may also be compared to the given time stamp value (e.g., 10,625 microseconds) of FIG. 5A. In order to refer to the same store instruction, the two time stamp values should generally be fairly nearby in time, such as, for example, being within on the order of around ten microseconds of one another, in most cases. In this simple example, only a single virtual address and time stamp are being considered, although it is to be appreciated that when there are many such virtual addresses to compare, and many such time stamp values to compare, having identical virtual addresses, and optionally also having nearby in time timestamps, may be useful for such correlation. Once correlated, the associated instruction pointer may be readily identified from the corresponding set of data from FIG. 5A. This may identify, or at least help to identify, instruction pointers of, or at least relatively close to (e.g., relatively small skid), stores that cause remote transactions to abort.

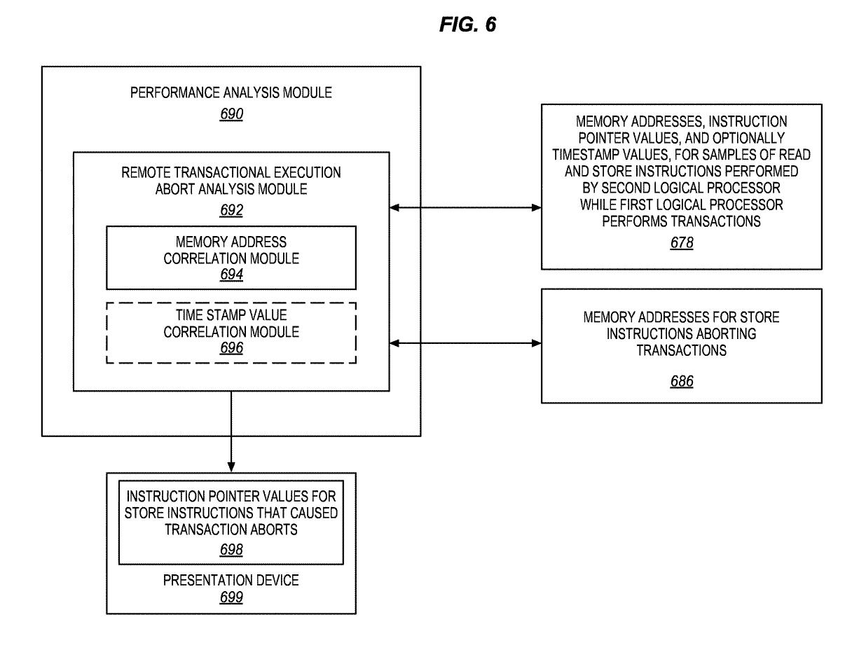

FIG. 6 is a block diagram of a performance analysis module 690 having an embodiment of a remote transactional execution abort analysis module 692. The performance analysis module may represent a performance profiling module. One specific suitable example of performance analysis module is the Intel® VTune™ Amplifier performance analyzer, available from Intel Corporation, of Santa Clara, Calif., although the scope of the invention is not so limited.

The remote transactional execution abort analysis module may access a first set of data 678. Examples of a suitable first set of data 678 are the first set of data 478 and/or the first set of data 578. The first set of data 678 includes memory addresses of, and instruction pointer values associated with, at least a sample of read from memory instructions, and store to memory instructions, which have been performed by a second logical processor, while a first logical processor has performed multiple transactional execution transactions. In some cases, this first set of data may also optionally include corresponding time stamp values, although this is not required.

The remote transactional execution abort analysis module may also access a second set of data 686. Examples of a suitable second set of data 686 are the second set of data 486 and/or the second set of data 586. The second set of data 686 includes a memory addresses for store to memory instructions, which have bene performed by the second logical processor, which have aborted the transactional execution transactions performed by the first logical processor. In some cases, this second set of data may also optionally include corresponding time stamp values corresponding to these store to memory instructions that have aborted the transactions, although this is not required.

These two sets of data may represent the output of two different memory address performance monitoring events. These two sets of data may be combined, compared, or otherwise correlated in a post-processing operation to identify the instruction pointers of store to memory instructions that have caused remote (e.g., performed on another logical processor) transactions to abort.

The transactional execution remote abort analysis module includes a memory address correlation module 694. The transactional execution remote abort analysis module may be operative to determine instruction pointer values associated with the store to memory instructions that have aborted transactions by correlating at least the memory addresses for the store to memory instructions that have aborted the transactions of the second set of data 686, with the memory addresses of at least the sample of the read from memory instructions and the store to memory instructions of the first sample 678. For example, matching or identical memory addresses in each set may be identified. If needed, physical memory addresses in the second set 686 may optionally first be converted to virtual memory addresses, as previously described, and compared with virtual memory addresses of the first set 678. Alternatively, virtual memory addresses in the first set of data 678 may instead optionally first be converted to physical memory addresses for comparison with physical memory addresses in the second set of data 686.

In some embodiments, the transactional execution remote abort analysis module may optionally include a time stamp value correlation module 696, although this is not required. The stamp value correlation module may be operative to perform temporal correlation of the time stamp values of the first and second sets 678, 686 to further help to identify the instruction pointers of store to memory instructions that have caused transactions to abort.

The correlation of the memory addresses and the timestamps may be performed in different orders depending upon the particular approach used for correlation. In one aspect, the memory addresses may optionally first be correlated, before the time stamp values are correlated. For example, the time stamp values may be used to further filter out matching memory addresses which have time stamp values which are sufficiently proximate in time from those that do not. Alternatively, the time stamp values may optionally first be correlated, before the memory addresses are correlated. For example, the data may be combined and sorted by time stamp value and then nearby matching memory addresses may be identified.

Once identified, the instruction pointer values 698 of or associated with (nearby with small skid) store to memory instructions that caused transactions to abort may then be output as remote transaction abort causing stores (e.g., a remote transaction killers). For example, they may be output to a display device, monitor, printer, graphic user interface, or other presentation device. In addition, the data addresses may also optionally be output or presented to provide additional information (e.g., to a programmer) on the abort causes. Advantageously, this may allow a programmer to more quickly identify these remote transaction aborting stores, which may in some cases allow the software to be tuned to avoid them.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality.

Exemplary core architectures are described next, followed by descriptions of exemplary processors and computer architectures.

### Exemplary Core Architectures

### In-Order and Out-of-Order Core Block Diagram

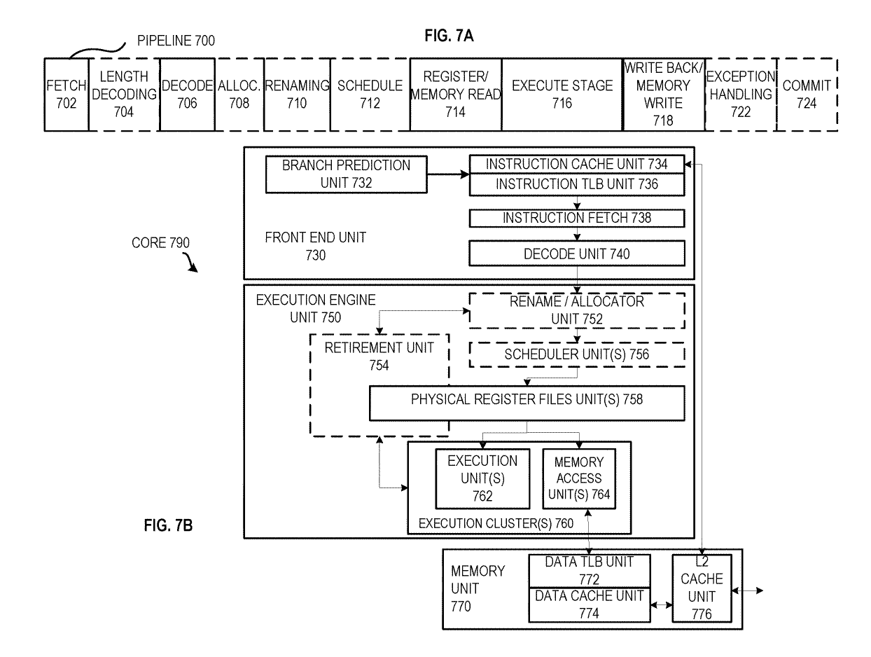

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary in-Order Core Architecture

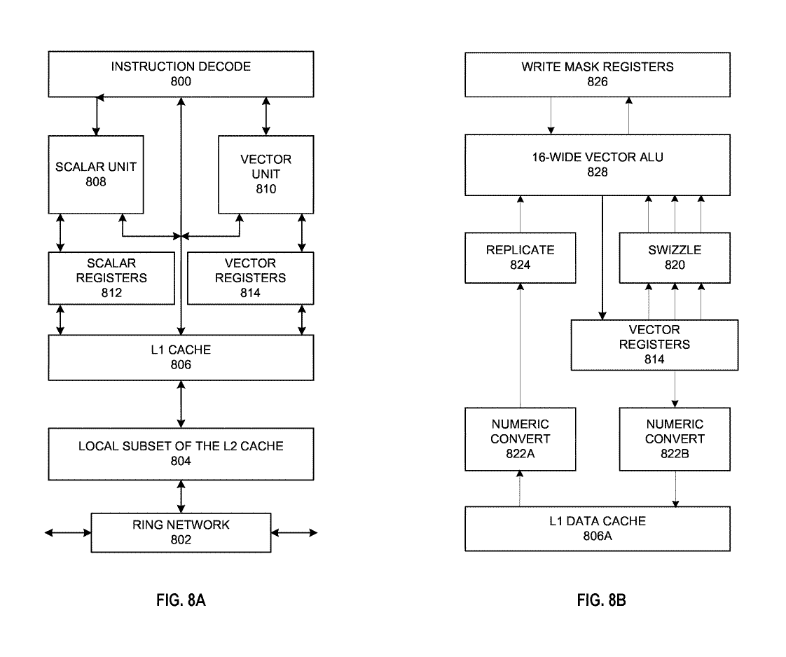

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

Processor with Integrated Memory Controller and Graphics

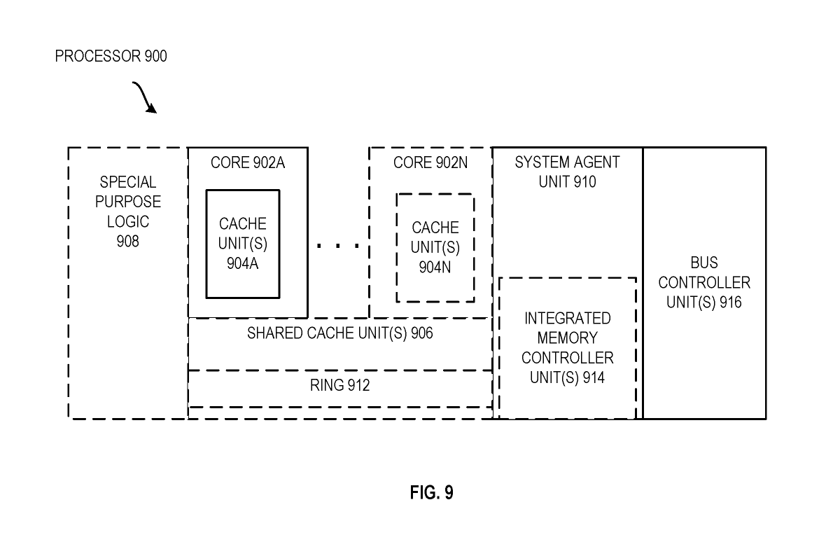

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

### Exemplary Computer Architectures

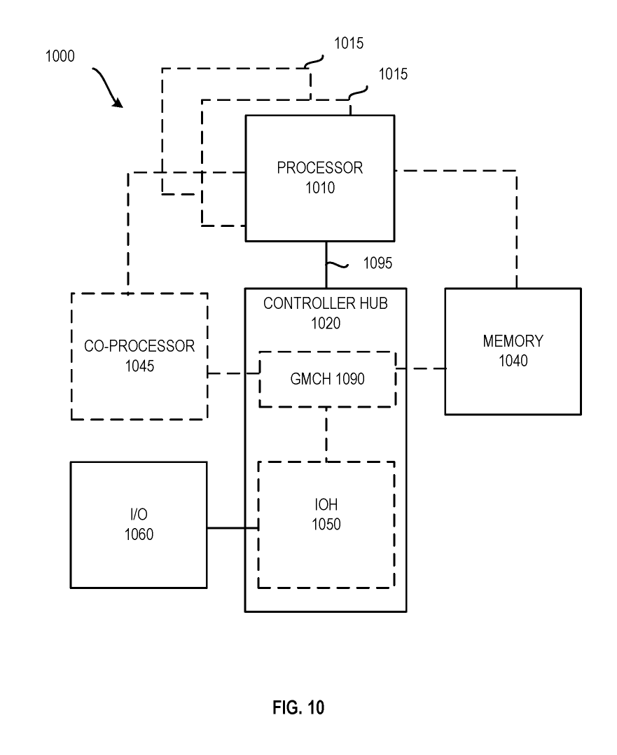

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processing cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, microarchitectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

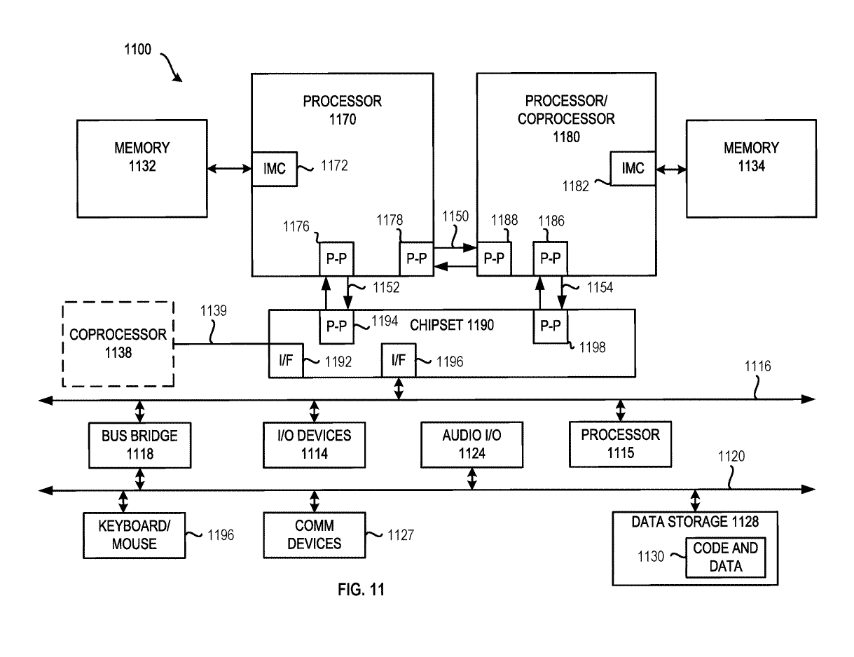

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

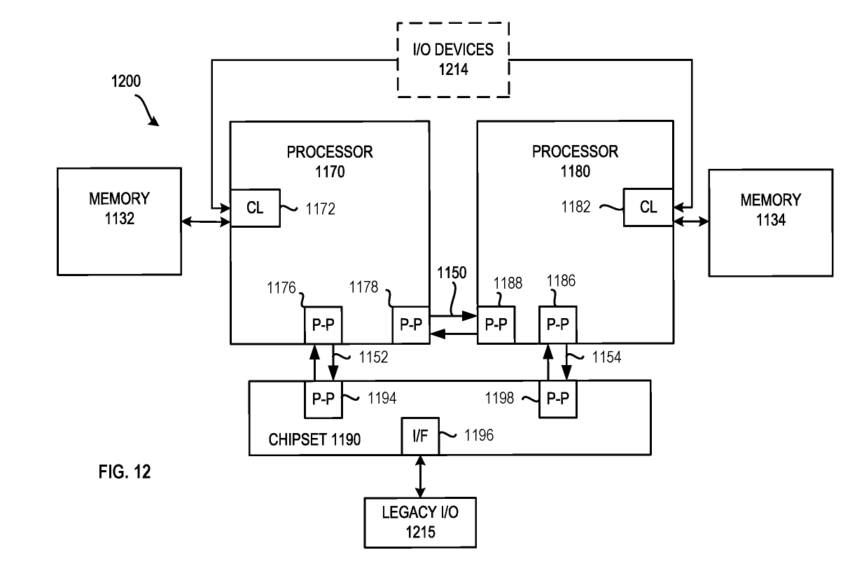

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

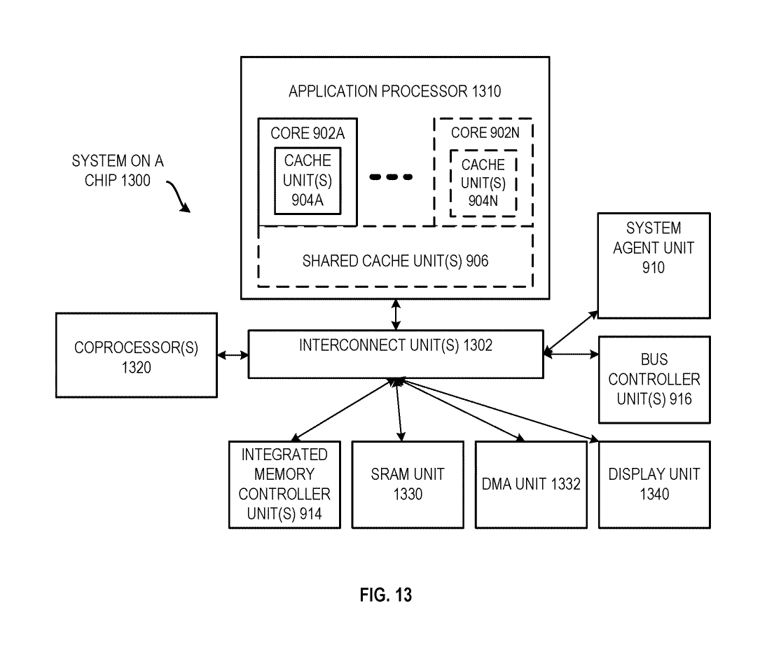

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 202A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

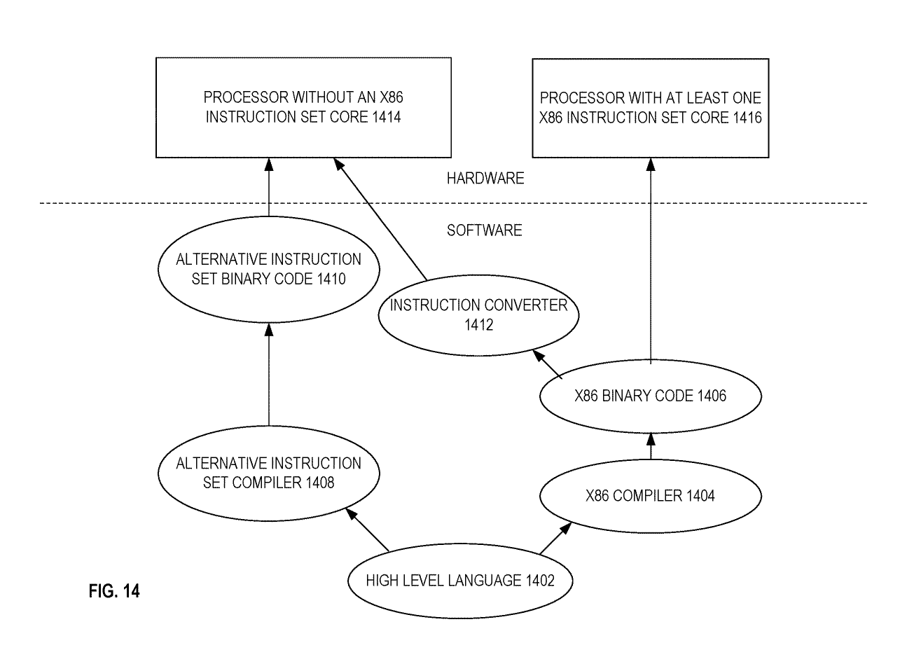

FIG. 14 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 14 shows a program in a high level language 1402 may be compiled using an x86 compiler 1404 to generate x86 binary code 1406 that may be natively executed by a processor with at least one x86 instruction set core 1416. The processor with at least one x86 instruction set core 1416 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1404 represents a compiler that is operable to generate x86 binary code 1406 (e.g., object code) that can, with or without additional linkage processing, be executed on the processor with at least one x86 instruction set core 1416. Similarly, FIG. 14 shows the program in the high level language 1402 may be compiled using an alternative instruction set compiler 1408 to generate alternative instruction set binary code 1410 that may be natively executed by a processor without at least one x86 instruction set core 1414 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1412 is used to convert the x86 binary code 1406 into code that may be natively executed by the processor without an x86 instruction set core 1414. This converted code is not likely to be the same as the alternative instruction set binary code 1410 because an instruction converter capable of this is difficult to make; however, the converted code will accomplish the general operation and be made up of instructions from the alternative instruction set. Thus, the instruction converter 1412 represents software, firmware, hardware, or a combination thereof that, through emulation, simulation or any other process, allows a processor or other electronic device that does not have an x86 instruction set processor or core to execute the x86 binary code 1406.

Components, features, and details described for any of the apparatus disclosed herein may optionally apply to any of the methods disclosed herein, which in embodiments may optionally be performed by and/or with such processors. Any of the processors described herein in embodiments may optionally be included in any of the systems disclosed herein.

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other.

The components disclosed herein and the methods depicted in the preceding figures may be implemented with logic, modules, or units that includes hardware (e.g., transistors, gates, circuitry, etc.), firmware (e.g., a non-volatile memory storing microcode or control signals), software (e.g., stored on a non-transitory computer readable storage medium), or a combination thereof. In some embodiments, the logic, modules, or units may include at least some or predominantly a mixture of hardware and/or firmware potentially combined with some optional software.

The term “and/or” may have been used. As used herein, the term “and/or” means one or the other or both (e.g., A and/or B means A or B or both A and B).

In the description above, specific details have been set forth in order to provide a thorough understanding of the embodiments. However, other embodiments may be practiced without some of these specific details. The scope of the invention is not to be determined by the specific examples provided above, but only by the claims below. In other instances, well-known circuits, structures, devices, and operations have been shown in block diagram form and/or without detail in order to avoid obscuring the understanding of the description. Where considered appropriate, reference numerals, or terminal portions of reference numerals, have been repeated among the figures to indicate corresponding or analogous elements, which may optionally have similar or the same characteristics, unless specified or clearly apparent otherwise.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, a sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches), Mobile Internet devices (MIDs), media players, smart televisions, nettops, set-top boxes, and video game controllers.

Reference throughout this specification to “one embodiment,” “an embodiment,” “one or more embodiments,” “some embodiments,” for example, indicates that a particular feature may be included in the practice of the invention but is not necessarily required to be. Similarly, in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of the invention.

### Example Embodiments

The following examples pertain to further embodiments. Specifics in the examples may be used anywhere in one or more embodiments.

Example 1 is a method of analyzing aborts of transactional execution transactions including starting a transactional execution transaction with a first logical processor, performing, with a second logical processor, store to memory instructions, while the first logical processor is performing the transactional execution transaction, capturing memory addresses of, and instruction pointer values associated with, at least a sample of the store to memory instructions, performing, with the second logical processor, a first store to memory instruction to a first memory address, which is to cause the transactional execution transaction to abort, capturing the first memory address, and determining an instruction pointer value associated with the first store to memory instruction by correlating at least the captured first memory address with the captured memory addresses of said at least the sample of the store to memory instructions.

Example 2 includes the method of claim 1, further including capturing time stamps associated with said at least the sample of the store to memory instructions, capturing a first time stamp associated with the first store to memory instruction, and correlating the captured first time stamp with the captured time stamps associated with said at least the sample of the store to memory instructions, as part of the determining the instruction pointer value.

Example 3 includes the method of claim 1, further including the first logical processor sending a cache coherency message to the second logical processor, and optionally in which the cache coherency message includes an indication of the abort of the transactional execution transaction.

Example 4 includes the method of claim 3, optionally in which said capturing the first memory address is responsive to receipt of the cache coherency message by the second logical processor.

Example 5 includes the method of any one of claims 1 to 4, further including the second logical processor waiting to remove an entry in a store buffer corresponding to a given store to memory instruction until a cache coherency message is received that indicates whether or not the given store to memory instruction has caused the transactional execution transaction to abort.

Example 6 includes the method of any one of claims 1 to 4, optionally in which said capturing the instruction pointer values is performed with a relatively more time precise performance monitoring approach that is relatively more time precise than a performance monitoring approach used for said capturing the first memory address.

Example 7 includes the method of any one of claims 1 to 4, optionally in which said performing the first store to memory instruction includes performing the first store to memory instruction with the first memory address which has a data conflict with one of a read-set and a write-set of the transactional execution transaction.

Example 8 is a processor including a first logical processor. The first logical processor including transactional execution logic to start a transactional execution transaction, a second logical processor to perform store to memory instructions, including a first store to memory instruction to a first memory address, while the transactional execution transaction is to be performed by the first logical processor, and a performance monitor unit to capture memory addresses of, and instruction pointer values associated with, at least a sample of the store to memory instructions, and capture the first memory address, when the first memory address is to cause the transaction to abort.

Example 9 includes the processor of claim 8, optionally in which the performance monitor unit is to capture the first memory address, in response to an indication, from the first logical processor, that the first memory address has caused the transactional execution transaction to abort.

Example 10 includes the processor of claim 9, optionally in which the first logical processor includes a cache, and optionally in which the cache, when the first memory address will cause the transactional execution transaction to abort, it to send a cache coherency message to the second logical processor that is to include the indication.

Example 11 includes the processor of claim 10, optionally in which the cache is to include the indication in a field of the cache coherency message.

Example 12 includes the processor of claim 8, optionally in which the second logical processor includes a store buffer, and optionally in which the store buffer is to wait to remove an entry, which is to correspond to a given store to memory instruction, until receipt of an indication from the first logical processor of whether the given store to memory instruction will cause a transactional execution transaction to abort.

Example 13 includes the processor of any one of claims 8 to 12, optionally in which the performance monitor unit is further to capture time stamps associated with said at least a sample of the store to memory instructions, and capture a first time stamp associated with the first store to memory instruction.

Example 14 includes the processor of any one of claims 8 to 12, optionally in which the performance monitor unit is to capture the instruction pointer values with a relatively more time precise performance monitor approach than one used to capture the first memory address.

Example 15 includes the processor of any one of claims 8 to 12, optionally in which the first memory address is to cause the transactional execution transaction to abort when it conflicts with one of a read-set and a write-set of the transactional execution transaction.

Example 16 includes the processor of any one of claims 8 to 12, optionally in which the performance monitor unit is to capture the first memory address which is to be a physical memory address.

Example 17 includes the processor of any one of claims 8 to 12, optionally in which the performance monitor unit is to capture the first memory address which is to be a virtual memory address.

Example 18 is a computer system including a processor. The processor including a first logical processor, the first logical processor including transactional execution logic to start a transactional execution transaction, a second logical processor to perform store to memory instructions, including a first store to memory instruction to a first memory address, while the transactional execution transaction is to be performed by the first logical processor, and a performance monitor unit to capture memory addresses of, and instruction pointer values associated with, at least a sample of the store to memory instructions, and capture the first memory address, when the first memory address is to cause the transaction to abort, and a dynamic random access memory coupled with the processor. The dynamic random access memory storing a set of instructions, the set of instructions, if executed by the computer system, to cause the computer system to perform operations including determining an instruction pointer value associated with the first store to memory instruction by correlating at least the captured first memory address with the captured memory addresses of said at least the sample of the store to memory instructions.

Example 19 is the computer system of claim 18, optionally in which the set of instructions further include instructions that if executed by the computer system are to cause the computer system to perform operations including correlating a captured first time stamp associated with the first store to memory instruction with captured time stamps associated with said at least the sample of the store to memory instructions.

Example 20 is an article of manufacture including a non-transitory machine-readable storage medium, the non-transitory machine-readable storage medium storing a set of instructions. The set of instructions, if executed by a machine, to cause the machine to perform operations including, accessing memory addresses of, and instruction pointer values associated with, at least a sample of store to memory instructions, which are to have been performed by a second logical processor while a transactional execution transaction was being performed with a first logical processor, accessing a first memory address associated with a first store to memory instruction, which is to have caused an abort of the transactional execution transaction, and determining an instruction pointer value associated with the first store to memory instruction by correlating at least the first memory address with the memory addresses of said at least the sample of the store to memory instructions.

Example 21 includes the article of manufacture of claim 20, optionally in which the set of instructions further comprise instructions that if executed by the machine are to cause the machine to perform operations including correlating a captured first time stamp associated with the first store to memory instruction with captured time stamps associated with said at least the sample of the store to memory instructions, as part of said determining the instruction pointer value.

Example 22 includes the article of manufacture of claim 21, optionally in which the instructions further comprise instructions that if executed by the machine are to cause the machine to perform operations including correlating the first memory address with the memory addresses before correlating the first time stamp with the time stamps.

Example 23 includes the article of manufacture of claim 21, optionally in which the instructions further comprise instructions that if executed by the machine are to cause the machine to perform operations including correlating the first time stamp with the time stamps before correlating the first memory address with the memory addresses.

Example 24 includes the article of manufacture of any one of claims 20 to 23, optionally in which the instructions to determine the instruction pointer value further comprise instructions that if executed by the machine are to cause the machine to perform operations including match the first memory address to an identical memory address in the memory addresses.

Example 25 includes the article of manufacture of any one of claims 20 to 23, optionally in which the instructions further comprise instructions that if executed by the machine are to cause the machine to perform operations including reporting the instruction pointer value as being associated with a remote transaction killer.

Example 26 is a processor or other apparatus operative to perform the method of any one of Examples 1 to 7.

Example 27 is a processor or other apparatus that includes means for performing the method of any one of Examples 1 to 7.

Example 28 is a processor or other apparatus that includes any combination of modules and/or units and/or logic and/or circuitry and/or means operative to perform the method of any one of Examples 1 to 7.

Example 29 is a processor or other apparatus substantially as described herein.

Example 30 is a processor or other apparatus that is operative to perform any method substantially as described herein.

What is claimed is:

1. A method of analyzing aborts of transactional execution transactions comprising:
starting a transactional execution transaction with a first logical processor;
performing, with a second logical processor, store to memory instructions, while the first logical processor is performing the transactional execution transaction;
capturing memory addresses of, and instruction pointer values associated with, at least a sample of the store to memory instructions;
performing, with the second logical processor, a first store to memory instruction to a first memory address, which is to cause the transactional execution transaction to abort;
capturing the first memory address; and
determining an instruction pointer value associated with the first store to memory instruction by correlating at least the captured first memory address with the captured memory addresses of said at least the sample of the store to memory instructions.

2. The method of claim 1, further comprising:
capturing time stamps associated with said at least the sample of the store to memory instructions;
capturing a first time stamp associated with the first store to memory instruction; and
correlating the captured first time stamp with the captured time stamps associated with said at least the sample of the store to memory instructions, as part of the determining the instruction pointer value.

3. The method of claim 1, further comprising the first logical processor sending a cache coherency message to the second logical processor, and wherein the cache coherency message includes an indication of the abort of the transactional execution transaction.

4. The method of claim 3, wherein said capturing the first memory address is responsive to receipt of the cache coherency message by the second logical processor.

5. The method of claim 1, further comprising the second logical processor waiting to remove an entry in a store buffer corresponding to a given store to memory instruction until a cache coherency message is received that indicates whether or not the given store to memory instruction has caused the transactional execution transaction to abort.

6. The method of claim 1, wherein said capturing the instruction pointer values is performed with a relatively more time precise performance monitoring approach that is relatively more time precise than a performance monitoring approach used for said capturing the first memory address.

7. The method of claim 1, wherein said performing the first store to memory instruction comprises performing the first store to memory instruction with the first memory address which has a data conflict with one of a read-set and a write-set of the transactional execution transaction.

8. A processor comprising:
a first logical processor, the first logical processor including:
transactional execution logic to start a transactional execution transaction;
a second logical processor to perform store to memory instructions, including a first store to memory instruction to a first memory address, while the transactional execution transaction is to be performed by the first logical processor; and
a performance monitor unit to:
capture memory addresses of, and instruction pointer values associated with, at least a sample of the store to memory instructions; and
capture the first memory address, when the first memory address is to cause the transaction to abort.

9. The processor of claim 8, wherein the performance monitor unit is to capture the first memory address, in response to an indication, from the first logical processor, that the first memory address has caused the transactional execution transaction to abort.

10. The processor of claim 9, wherein the first logical processor comprises a cache, and wherein the cache, when the first memory address will cause the transactional execution transaction to abort, it to send a cache coherency message to the second logical processor that is to include the indication.

11. The processor of claim 10, wherein the cache is to include the indication in a field of the cache coherency message.

12. The processor of claim 8, wherein the second logical processor comprises a store buffer, and wherein the store buffer is to wait to remove an entry, which is to correspond to a given store to memory instruction, until receipt of an indication from the first logical processor of whether the given store to memory instruction will cause a transactional execution transaction to abort.

13. The processor of claim 8, wherein the performance monitor unit is further to:
capture time stamps associated with said at least a sample of the store to memory instructions; and
capture a first time stamp associated with the first store to memory instruction.

14. The processor of claim 8, wherein the performance monitor unit is to capture the instruction pointer values with a relatively more time precise performance monitor approach than one used to capture the first memory address.

15. The processor of claim 8, wherein the first memory address is to cause the transactional execution transaction to abort when it conflicts with one of a read-set and a write-set of the transactional execution transaction.

16. The processor of claim 8, wherein the performance monitor unit is to capture the first memory address which is to be a physical memory address.

17. The processor of claim 8, wherein the performance monitor unit is to capture the first memory address which is to be a virtual memory address.

18. A computer system comprising:
a processor, the processor comprising:
a first logical processor, the first logical processor including:
transactional execution logic to start a transactional execution transaction;
a second logical processor to perform store to memory instructions, including a first store to memory instruction to a first memory address, while the transactional execution transaction is to be performed by the first logical processor; and
a performance monitor unit to:
capture memory addresses of, and instruction pointer values associated with, at least a sample of the store to memory instructions; and
capture the first memory address, when the first memory address is to cause the transaction to abort; and
a dynamic random access memory coupled with the processor, the dynamic random access memory storing a set of instructions, the set of instructions, if executed by the computer system, to cause the computer system to perform operations comprising determining an instruction pointer value associated with the first store to memory instruction by correlating at least the captured first memory address with the captured memory addresses of said at least the sample of the store to memory instructions.

19. The computer system of claim 18, wherein the set of instructions further include instructions that if executed by the computer system are to cause the computer system to perform operations comprising correlating a captured first time stamp associated with the first store to memory instruction with captured time stamps associated with said at least the sample of the store to memory instructions.

20. An article of manufacture comprising a non-transitory machine-readable storage medium, the non-transitory machine-readable storage medium storing a set of instructions, the set of instructions, if executed by a machine, to cause the machine to perform operations comprising:
accessing memory addresses of, and instruction pointer values associated with, at least a sample of store to memory instructions, which are to have been performed by a second logical processor while a transactional execution transaction was being performed with a first logical processor;
accessing a first memory address associated with a first store to memory instruction, which is to have caused an abort of the transactional execution transaction; and
determining an instruction pointer value associated with the first store to memory instruction by correlating at least the first memory address with the memory addresses of said at least the sample of the store to memory instructions.

21. The article of manufacture of claim 20, wherein the set of instructions further comprise instructions that if executed by the machine are to cause the machine to perform operations comprising correlating a captured first time stamp associated with the first store to memory instruction with captured time stamps associated with said at least the sample of the store to memory instructions, as part of said determining the instruction pointer value.

22. The article of manufacture of claim 21, wherein the instructions further comprise instructions that if executed by the machine are to cause the machine to perform operations comprising correlating the first memory address with the memory addresses before correlating the first time stamp with the time stamps.

23. The article of manufacture of claim 21, wherein the instructions further comprise instructions that if executed by the machine are to cause the machine to perform operations comprising correlating the first time stamp with the time stamps before correlating the first memory address with the memory addresses.

24. The article of manufacture of claim 20, wherein the instructions to determine the instruction pointer value further comprise instructions that if executed by the machine are to cause the machine to perform operations comprising match the first memory address to an identical memory address in the memory addresses.

25. The article of manufacture of claim 20, wherein the instructions further comprise instructions that if executed by the machine are to cause the machine to perform operations comprising reporting the instruction pointer value as being associated with a remote transaction killer.
